(19) United States
(12) Patent Application Publication
(10) Pub. No.: US 2020/0108410 A1
(43) Pub. Date: Apr. 9, 2020

(54) Support Stand

(71) Applicant: Steve Buttram, Helenwood, TN (US)

(72) Inventor: Steve Buttram, Helenwood, TN (US)

(21) Appl. No.: 16/150,601

(22) Filed: Oct. 3, 2018

(51) Int. Cl. B05B 15/62

(52) U.S. Cl. CPC B05B 15/62

(57) ABSTRACT

A support stand for a spray gun hopper assembly includes a box that defines an interior space. The box has a bottom, a top, opposing sides, a back, and a front that is open. A cutout extends into the top from the front toward the back. The cutout is configured to insert a hopper of the spray gun hopper assembly, positioning a spray gun of the spray gun hopper assembly in the interior space. The box is configured to support the hopper in a position for a user to add a compound to the hopper, such as a gravity fed texturing material.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relate to stands and more particularly pertains to a new stand for a spray gun hopper assembly.

### BRIEF SUMMARY OF THE INVENTION

An embodiment of the disclosure meets the needs presented above by generally comprising a box that defines an interior space. The box has a bottom, a top, opposing sides, a back, and a front that is open. A cutout extends into the top from the front toward the back. The cutout is configured to insert a hopper of a spray gun hopper assembly, positioning a spray gun of the spray gun hopper assembly in the interior space. The box is configured to support the hopper in a position for a user to add a compound to the hopper, such as a gravity fed texturing material.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a support stand according to an embodiment of the disclosure.

FIG. 2 is a bottom view of an embodiment of the disclosure.

FIG. 3 is a top view of an embodiment of the disclosure.

FIG. 4 is a front view of an embodiment of the disclosure.

FIG. 5 is an in-use view of an embodiment of the disclosure.

### DETAILED DESCRIPTION OF THE INVENTION

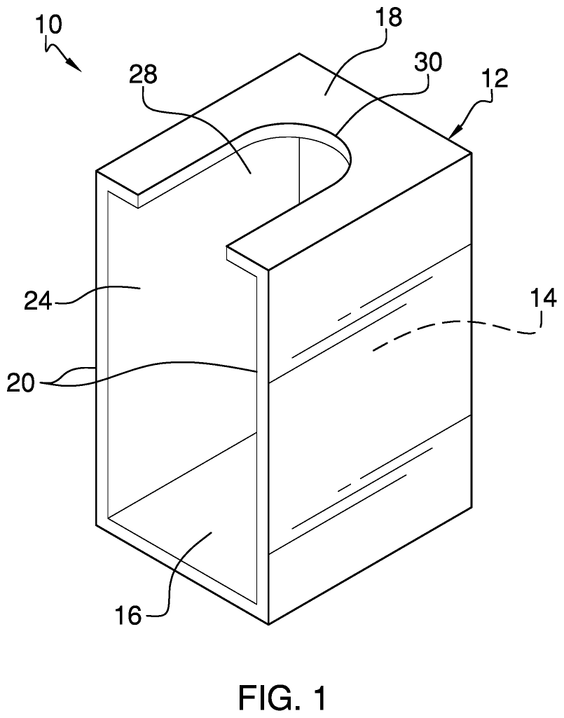

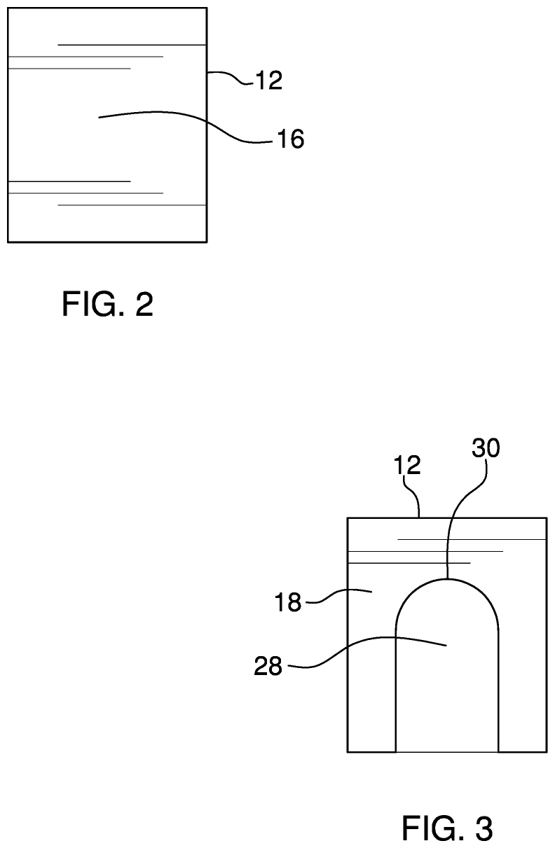

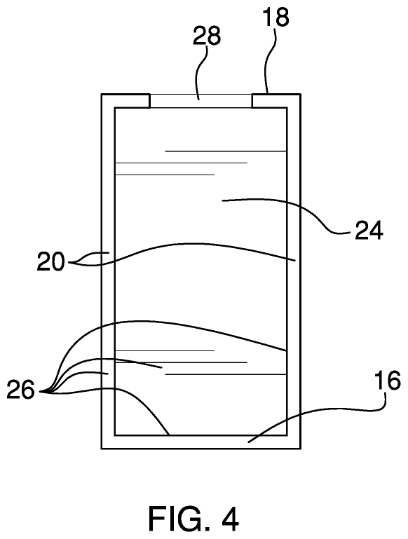

With reference now to the drawings, and in particular to FIGS. 1 through 5 thereof, a new stand embodying the principles and concepts of an embodiment of the disclosure and generally designated by the reference numeral 10 will be described.

As best illustrated in FIGS. 1 through 5, the support stand 10 generally comprises a box 12 that defines an interior space 14. The box 12 has a bottom 16, a top 18, opposing sides 20, a back 22, and a front 24 that is open. The bottom 16, the back 22, and the opposing sides 20 comprise solid panels 26. The box 12 comprises at least one of wood and plastic. In one embodiment, the top 18 and the bottom 16 are separated by 60.0 to 80.0 centimeters and the opposing sides 20 are separated by 22.0 to 38.0 centimeters. In another embodiment, the top 18 and the bottom 16 are separated by 65.0 to 75.0 centimeters and opposing sides 20 are separated by 28.0 to 35.0 centimeters. In yet another embodiment, the top 18 and the bottom 16 are separated by 68.6 centimeters and the opposing sides 20 are separated by 30.5 centimeters.

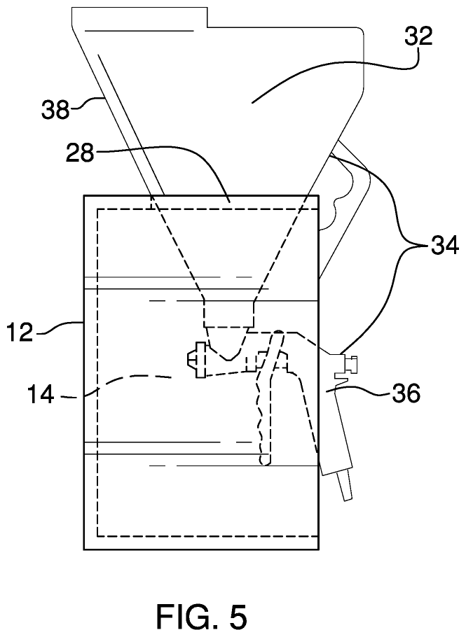

A cutout 28 extends into the top 18 from the front 24 toward the back 22, as shown in FIG. 3. The cutout 28 extends to proximate to the back 22. The cutout 28 has a terminus 30, distal from the front 24, that is arcuate. The cutout 28 is configured to insert a hopper 32 of a spray gun hopper assembly 34 so that the hopper 32 is substantially centered relative to the top 18 when the hopper 32 is fully inserted into the cutout 28 positioning a spray gun 36 of the spray gun hopper assembly 34 in the interior space 14, as shown in FIG. 5. The terminus 30 of the cutout 28, being arcuate, is complementary to a sidewall 38 of the hopper 32, thereby stabilizing the hopper 32 relative to the box 12. The box 12 is configured to support the hopper 32 in a position for a user to add a compound to the hopper 32, such as a gravity fed texturing material. The box 12 allows the user to easily add the compound to the hopper 32, an otherwise difficult and potentially messy task for one person.

In use, the hopper 32 of the spray gun hopper assembly 34 is fully inserted into the cutout 28 so that the hopper 32 is substantially centered relative to the top 18, positioning the spray gun 36 in the interior space 14. The compound then is added to the hopper 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A support stand comprising:
a box defining an interior space, the box having a bottom, a top, opposing sides, a back, and a front, the front being open; and
a cutout extending into the top from the front toward the back wherein the cutout is configured for inserting a hopper of a spray gun hopper assembly positioning a spray gun of the spray gun hopper assembly in the interior space wherein the box is configured for supporting the hopper in a position for adding a compound to the hopper.

2. The stand of claim 1, further including the bottom, the back, and the opposing sides comprising solid panels.

3. The stand of claim 2, further including the box comprising at least one of wood and plastic.

4. The stand of claim 1, further including the top and the bottom being separated by 60.0 to 80.0 centimeters, the opposing sides being separated by 22.0 to 38.0 centimeters.

5. The stand of claim 4, further including the top and the bottom being separated by 65.0 to 75.0 centimeters, the opposing sides being separated by 28.0 to 35.0 centimeters.

6. The stand of claim 5, further including the top and the bottom being separated by 68.6 centimeters, the opposing sides being separated by 30.5 centimeters.

7. The stand of claim 1, further including the cutout extending to proximate to the back such that the hopper is substantially centered relative to the top when the hopper is fully inserted into the cutout.

8. The stand of claim 7, further including the cutout having a terminus distal from the front, the terminus being arcuate.

9. A support stand and a spray gun hopper assembly combination comprising:
a spray gun hopper assembly comprising a spray gun operationally coupled to a hopper;
a box defining an interior space, the box having a bottom, a top, opposing sides, a back, and a front, the front being open; and
a cutout extending into the top from the front toward the back wherein the cutout is configured for inserting the hopper positioning the spray gun in the interior space wherein the box is positioned for supporting the hopper in a position for adding a compound to the hopper.

10. A support stand comprising:
a box defining an interior space, the box having a bottom, a top, opposing sides, a back, and a front, the front being open, the bottom, the back, and the opposing sides comprising solid panels, the box comprising at least one of wood and plastic, the top and the bottom being separated by 60.0 to 80.0 centimeters, the opposing sides being separated by 22.0 to 38.0 centimeters; and
a cutout extending into the top from the front toward the back wherein the cutout is configured for inserting a hopper of a spray gun hopper assembly positioning a spray gun of the spray gun hopper assembly in the interior space wherein the box is configured for supporting the hopper in a position for adding a compound to the hopper, the cutout extending to proximate to the back such that the hopper is substantially centered relative to the top when the hopper is fully inserted into the cutout, the cutout having a terminus distal from the front, the terminus being arcuate.

11. The stand of claim 10, further including the top and the bottom being separated by 65.0 to 75.0 centimeters, the opposing sides being separated by 28.0 to 35.0 centimeters.

12. The stand of claim 11, further including the top and the bottom being separated by 68.6 centimeters, the opposing sides being separated by 30.5 centimeters.
